(19) United States
(12) Patent Application Publication
(10) Pub. No.: US 2014/0372861 A1
(43) Pub. Date: Dec. 18, 2014

(54) Browser Plug-In and a Method of Operating a Browser Plug-In

(71) Applicant: MasterCard International Incorporated, Purchase, NY (US)

(72) Inventors: Paul LAWLESS, Dublin (IE); Robert CAMPION, Meath (IE)

(73) Assignee: MasterCard International Incorporated, Purchase, NY (US)

(21) Appl. No.: 14/304,110

(22) Filed: Jun. 13, 2014

(30) Foreign Application Priority Data
Jun. 14, 2013 (GB) 1310643.0

(51) Int. Cl. G06F 17/24; G06F 3/0481; G06F 17/22

(52) U.S. Cl. CPC G06F 17/243; G06F 17/2247; G06F 3/0481
USPC 715/224

(57) ABSTRACT

A method of operating a plug-in for a web browser comprises providing an identifier of a web page being displayed by said web browser to a server, receiving from the server at least one identifier associating an attribute with a form field of the web page and obtaining a respective user value associated with each of the least one attribute identifiers. Each form field of the web page is completed with an associated attribute value for the user. A user selection of at least one further attribute identifier is received and for each selected further attribute identifier, a user selection of a form field from said web page associated with one of said at least one further attribute identifier is received. An indicator associating said selected form field of said web page and said attribute identifier is provided to said server.

### FIELD

The present invention relates to a browser plugin, to enable a user to securely provide personal information to a web server.

### BACKGROUND

It is known for browser plugins to store information such as email addresses and passwords. Some password manager applications even store credit card details. However, because of the lack of uniformity among web sites, such plug-ins have limited utility enabling users to only store limited information and to work with a limited range of web sites. Furthermore, the layout of fields and fieldnames in webforms is known to change with revisions to websites, and this reduces the utility of these plugins across website revisions. Still furthermore, each individual has to enter information into the fields of a webform the first time for their plugin to learn which fields to populate with the correct information.

It is an object of the present invention to facilitate a distributed approach to enabling users to store and re-use their information for as many web sites as possible which might require this information.

### SUMMARY

According to the present invention, there is provided a method of operating a plug-in for a web browser according to claim 1.

Further aspects of the invention provide a plug-in for a web browser and a computer program product comprising a computer readable medium with instructions stored thereon which when executed on a computing device provides a plug-in for a web browser.

The invention provides a plugin for browsers including Chrome, FireFox, or Internet Explorer which can enable a user's information including their credit card details to be securely stored, so that they can be provided with a minimum of user interaction into the relevant fields of a website, for example, a merchant's checkout page.

The invention is based on crowd-sourcing form data to enable the auto-filling of form fields in web sites that any users of a service might have visited previously.

The details of which form fields correspond to which user attribute on any website are stored on one or more servers accessible to web clients running the plugin.

### BRIEF DESCRIPTION OF THE DRAWINGS

Embodiments of the invention will now be described, by way of example, with reference to the accompanying drawings, in which:

FIG. 1 is a schematic diagram of a network in which a client computing running a browser has a plug-in according to an embodiment of the invention; and

FIG. 2 is a flow diagram illustrating the operation of a browser plug-in and server according to one embodiment of the present invention.

### DESCRIPTION OF THE PREFERRED EMBODIMENTS

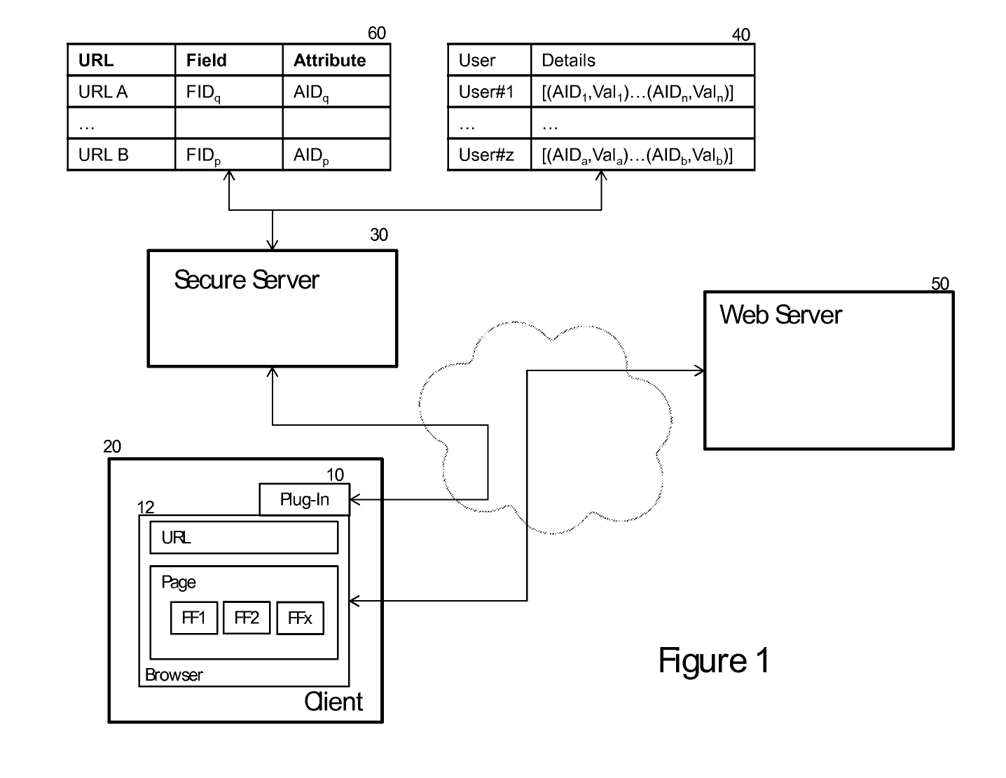

Referring first to FIG. 1 and explaining the invention most generally, a user wishing to avail of the present invention first of all downloads and installs a plugin 10 for a browser 12 running on a client computing device 20 of theirs. It is not unusual now for users to access the Internet from multiple client computers and to cater for such users; user's personal information input through the plug-in as described below can be stored in a central database 40 where it is accessible to a secure central server 30. In other implementations, a user's information could be stored on a portable storage device such as a smart card or memory stick which they make available to the plug-in locally on whichever client machine they are using.

Once installed, the plugin 10 can be arranged to allow the user at this stage to directly input their information for any web site form fields which are to be recognized by the plugin in due course, although this is not strictly necessary. Nonetheless, any user attribute value, for example, name, address, date of birth, credit card number, expiry date, which the user enters, can be stored either in the database 40; or as mentioned above, in other implementations, in a secure local store (not shown) accessible to the plug-in.

It will be appreciated that the information stored for each user need not correspond to the information stored for other users. So, for example, some users may input a minimal set of information whereas others may provide more extensive information. Some users may be prepared to store extremely sensitive information such as credit card information, whereas others may not. As such the set of attribute/value pairs stored in the database 40 for each user may not even overlap, yet alone coincide. It should also be appreciated that user information need not be simply a text value which in due course would be input into a text entry field. Users, who for example, indicate their sex, could have this information used for selecting check boxes or indeed automatic interaction with any other input interface input widget. Nonetheless, the term “form field” is used in the present specification to cover any user interface widget into which a user's personal information may be input. This personal information can equally include not alone a user's details such as name, age, credit card number etc. but also information such as their personal preferences such as for smoking or no smoking rooms, large or small cars, etc.

Storing a user's information at a central web server, allows a user who might employ this service via a number of different browsers, for example, from their desktop, tablet, smart-phone or other platform to avoid inputting their information several times. Nonetheless, storing the information locally or portably, may give users a greater sense of security in relation to their personal data.

In any case, once the plugin is installed, the user can use their browser as normal. When the user encounters selects a URL for a web page which requests user information for a web server 50, the user can then invoke the plugin to automatically fill the web page form fields with their attribute information.

This may require that the user explicitly log-in to the plug-in to enable the plug-in to access their stored information; and such users can be given the option to remain logged in at a given computer either permanently, for a given session or for a given time period. The particular details of securing communications and data storage as between the plug-in 12, server 30 and databases 40 and 60 can be entirely conventional and so they are not discussed further in the present specification.

If the user is the first plugin user to ever visit this web page, the plugin asks the user to select the web page form fields from the various fields FF1 . . . FFx corresponding to the attributes for which they have stored values. So for example, for a user who might be viewing a page which requires their name, date of birth, credit card number, expiry date and CVV number and where they have already stored such information, the user selects each such form field from the web page in turn and through interaction with the plug-in associates the form field with the attribute and so enables the plug-in to retrieve the user's value for each attribute and to populate the page form field with the value.

Equally, the plugin detects which fields the user has indicated are for each form field and the plugin then saves this data mapping form fields to attributes to a database 60 accessible to the central server 30.

When a subsequent plug-in user visiting the same web page opens their plugin, the plug-in can identify the stored mapping of fields to attributes for the web page in the database 60 and (once logged in) with as little as one click, the user's values can be input into the relevant form fields, because plugin immediately knows which form fields to populate based on the first visitors input.

It should be appreciated that users' information is stored separately from the information mapping web page form fields to attributes and so the provision of mapping information generated by one user to other users need never compromise the original user's personal data.

It will be see that subsequent visitors to a web page using the plugin of the present invention get the full benefit of the plugin, allowing them to have their information entered into form fields including any information entry objects or widgets of a web page with the minimum of interaction.

Even the first visitor to a web page using the plug-in benefits by not having to type out their personal information or, for example, physically take out their credit card and manually enter the details on every website they visit. This user just needs to identify which form fields correspond to which piece of user information, and the plugin will then automatically input their information.

Use of the present invention does not exclude the possibility of the plug-in on a visit to a web page intelligently identifying some form fields, for example, through the form field HTML tags such as Name, ID etc., and responsive to being requested by the user, automatically filling in user's information for such identified fields. In this case, the user would only have to identify or correct any fields that the plugin could not detect or identified incorrectly.

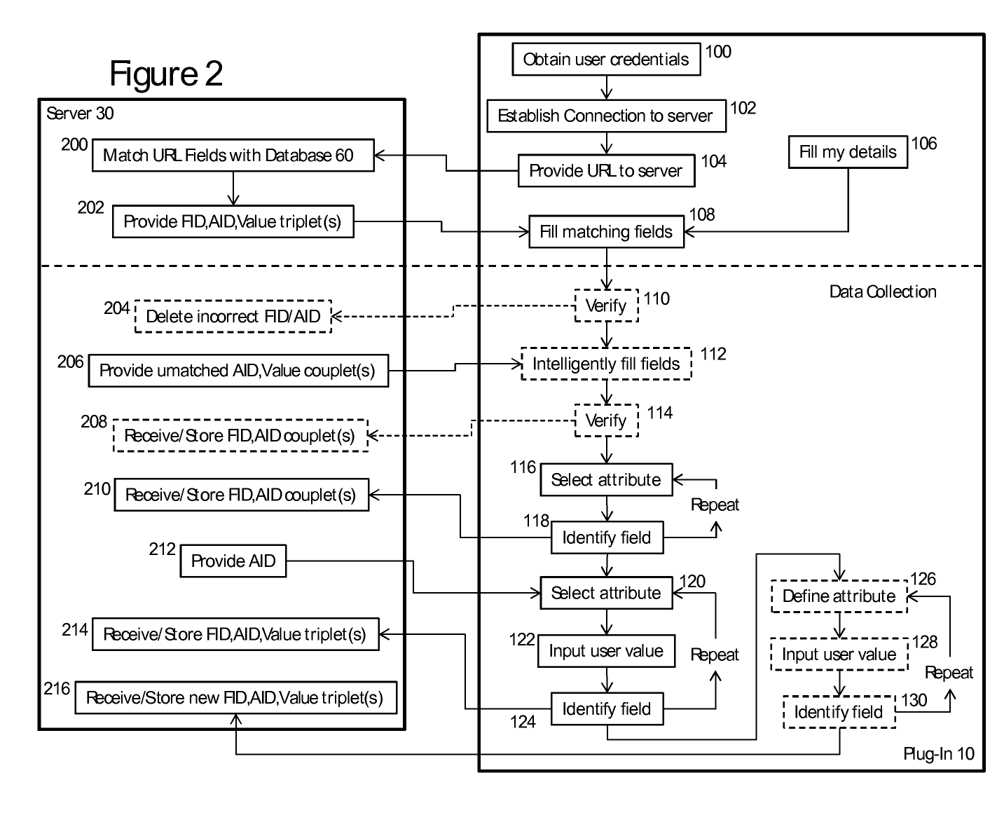

Having described implementations of the invention above most generally, and referring to FIG. 2, we would provide the following more detailed use case outlining an implementation of the invention within a browser such as Google Chrome with the plug-in installed:

1. A user opens their browser on a client device.

2. The user navigates to purchase item on a merchant website, for example, onlineshop.com.

3. The user reaches the checkout page having determined their purchases on the merchant website.

4. The user opens the plugin.

5. The plugin prompts the user to enter a password (and/or username), step 100.

6. The plugin verifies the user's credentials with the secure central server 30, using for example, standard HTML POST via HTTPS.

7. A secure session is created between the client device 20 and the server 30, step 102.

8. The current URL can be obtained by the plug-in using for example the following method call:

chrome.tabs.getSelected(null, function(tab) {
tabUrl = tab.url;
});

9. The URL is supplied by the plug-in 10 to the central server 30, step 104, which attempts to match the URL with any entries in the database 60, step 200, for example, as follows:
a. any cookie information/parameters are stripped from the supplied URL
b. a match is attempted
c. if no match is found the server side application will strip back the URL
d. a match is attempted
e. if no match is found the server side application will strip back the URL
f. . . . continued until it reaches the root URL only

### EXAMPLE

| | | |
|---|---|---|
| check | www.onlinestore.com/checkout/country/userid/product | NO |
| | | MATCH |
| check | www.onlinestore.com/checkout/country/userid | NO |
| | | MATCH |
| check | www.onlinestore.com/checkout/country | NO |
| | | MATCH |
| check | www.onlinestore.com/checkout/ | MATCH |

It should be appreciated that stripping can also include stripping the URL from the front, for example, in the above case removing www.

10. If the server 30 finds any matches in the database 60, the form field, attribute pairs (FID,AID) identified for the URL in the database 60 are returned to the plug-in as well as the users attribute value Valₓ for the identified form field/attribute from the database 40, step 202. This can be done with a JSON response containing triplets of the form: {field type, attribute identifier (name or id), value} for each identified form field.

11. At any stage after step 4 above, the user can click a “Fill my details” button displayed by the plug-in, step 106, and the plugin, once it has obtained the required information from the server 30 by parsing the JSON response, can fill the relevant form fields, step 108, for any identified form fields for which the user has supplied information in the database 40 using, for example, the method calls:

getElementById(‘fieldNameOrId’).value=“custvalue” OR

getElementsByName(‘fieldNameOrId’)[0].value=“custvalue”});

12. The plug-in now moves into a data collection mode. First, user can optionally be requested to verify that the information input for the various form fields is correct, step 110, and if not, the data for any field indicated as incorrect can be removed from the web page form field as well as the entry in the database 60 for the URL, step 204.

13. Even when a match has been found in the databases 60/40 for some form fields of a web page and these has been filled as described above, the server/plug-in can assist with filling/identifying other form fields both in the present session as well as in future sessions (for any other users). These additional fields can first be identified either by the server or the plug-in parsing HTML for the web page to extract any form elements and their ID/Name/Types etc. If any of the form fields have not been identified and filled by the previously described steps, the server (if it has parsed the page) can, for example, provide a JSON response via HTTPS containing the data available for the user, and the values from the database 40 where these have not been input previously into the web page, step 206. This message contains couplets of the form: {attribute identifier (name or id): value;} for each form field, for example: {CCNo:“1111222233334444”;Expiry:“0413”;NameOnCard:“Paul Lawless”; etc.}. (in other embodiments, where the plug-in parses the web page and determines that further form fields need to be filled in, it could request the above couplets from the server.)

14.As indicated above, the plug-in can attempt to fill in some of these additional form fields intelligently, step 112, based on their ID/Name/Types and using the method calls of step 11 above. These can be verified by the user, step 114 before being provided to and added by the server explicitly to the database 60, step 208. (No further information needs to be added to the database 40.)

15. If any further form fields remain to be filled/identified and the user wishes to continue in data collection mode, the plugin can now go through a sequence asking the user to select any of their previously unmatched attribute values, step 116, while also recording the ID/name/label/form position of the corresponding web page form field, step 118. So for example, the plug-in could display a menu or drop-down list including a list of attribute/values supplied at step 13 above and not intelligently filled at step 14 above. Once selected, the plug-in listens for example, for a click event on the background web page; or, when the user clicks the form field and returns to the plugin to click a “next” button, it reads the currently highlighted field on the web page. The plug-in gathers the element ID to be recorded, and fills the form field value as in step 11 above. This process is repeated until the user has matched all originally blank web page fields with attributes of theirs with pre-stored values.

16. Couplets comprising the collected form field identifiers and their corresponding attribute ID are then sent back by the plug-in to the server either on each click or in batch once the user has completed all fields, step 210, where they are stored along with the original (full) URL (minus any cookie/parameters) in the database 60 for future use. It will be appreciated that no user specific data needs to be returned or stored in the database 40 in this step.

17. There may still be fields for which a match is not available for the URL, and for which a user has not yet stored an attribute value. If so, the plug-in can therefore prompt the user to determine if the user is interested in providing such further information. If so, the server can supply the plug-in with a list of attribute identifiers which it is interested in having the user identify and for which the user might input an attribute value, step 212. Clearly, this list excludes any attributes which have been identified and filled in the previous steps. When a user selects any such attribute, step 120, they are then requested by the plug-in to input their attribute value, step 122—this is provided by the plug-in to the server for storage in the database 40 either immediately or subsequently once the corresponding form field(s) have been identified, step 124. Here, as in step 15, the plug-in listens for example, for a click event on the background web page; or, when the user clicks the field and returns to the plugin to click a “next” button, it reads the currently highlighted field on the web page. The plug-in gathers the element ID to be recorded, and fills the field value. This process is repeated until the user has matched any further originally blank web page fields with attributes and values of theirs.

18. The collected form field identifiers and their corresponding attribute ID are then sent back by the plug-in to the server, where they are stored along with the original (full) URL (minus any cookie/parameters) in the database 60 for future use; while the attribute ID and user value are stored in database 40, step 214.

19. In a final possibility, there may be still further form fields which the user may wish to define and supply to the server for possible future use. It will be appreciated that a service provider in attempting to provide the most ergonomic service might wish to limit the total number of attributes for which user information is to be stored and used. However, if large numbers of users for example identified a new attribute in common, for example, star sign, this could be adopted by the server for use in steps 10-18 above. In this case, the plug-in allows the user to define an identifier for a new attribute, step 126. The user then defines their value for that attribute, step 128. The user then identifies the form field on the web page, as before, for that attribute, step 130. Once complete, the triplet of information for each new attribute is returned to the server 30 which receives and stores the information in the databases 60 and 40, step 216, for future use.

It will be understood that the present disclosure may be embodied in a computer readable non-transitory storage medium storing instructions of a computer program which when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

1. A method of operating a plug-in for a web browser comprising the steps of:
providing an identifier of a web page being displayed by said web browser to a server;
receiving from the server at least one identifier associating an attribute with a form field of the web page;
obtaining a respective user value associated with each of the least one attribute identifiers;
completing each form field of the web page with an associated attribute value for the user;
receiving a user selection of at least one further attribute identifier;
for each selected further attribute identifier, receiving a user selection of a form field from said web page associated with one of said at least one further attribute identifier; and
providing an indicator associating said selected form field of said web page and said attribute identifier to said server.

2. A method according to claim 1 comprising receiving said at least one further attribute identifier from said server.

3. A method according to claim 1 further comprising the steps of:
for each said further attribute identifier, receiving a user value; and
completing an associated form field of the web page with the user value for the associated attribute identifier.

4. A method according to claim 3 further comprising:
receiving said user value for each said further attribute identifier from said user; and
storing said user value in association with said associated attribute identifier.

5. A method according to claim 3 further comprising:
receiving said user value for each said further attribute identifier either from said server or from local storage.

6. A method according to claim 1 further comprising the steps of:
receiving a user definition of at least one further attribute identifier;
for each user defined attribute identifier, receiving a user selection of a form field from said web page associated with one of said at least one user defined attribute identifier; and
providing an indicator associating said selected form field and said user defined attribute identifier to said server.

7. A method according to claim 6 further comprising the steps of:
for each said user defined attribute identifier, receiving a user value;
completing an associated form field of the web page with the user value for the user defined attribute identifier; and
storing said user value in association with said user defined attribute identifier.

8. A method according to claim 1 further comprising the steps of:
receiving a user verification that each form field of the web page has been completed correctly with an associated attribute value for the user; and
responsive to a negative verification, notifying said server accordingly.

9. A method according to claim 1 further comprising the steps of:
responsive to matching a form field of said web page with an attribute identifier for which said plug-in has obtained a value for said user, automatically completing said form field with said associated attribute value for the user.

10. A method according to claim 9 further comprising the steps of:
receiving a user verification that each automatically completed form field of the web page has been completed correctly with an associated attribute value for the user; and
responsive to a negative verification, notifying said server accordingly.

11. A method according to claim 9 wherein said step of automatically completing is performed prior to said step of receiving a user selection of at least one further attribute identifier.

12. A method according to claim 1 wherein said respective user values associated with each of the least one attribute identifiers are obtained either from said server or from storage local to said plug-in.

13. A plug-in for a web browser, the plug-in being arranged to:
provide an identifier of a web page being displayed by said web browser to a server;
receive from the server at least one identifier associating an attribute with a form field of the web page;
obtain a respective user value associated with each of the least one attribute identifiers;
complete each form field of the web page with an associated attribute value for the user;
receive a user selection of at least one further attribute identifier;
for each selected further attribute identifier, receive a user selection of a form field from said web page associated with one of said at least one further attribute identifier; and
provide an indicator associating said selected form field of said web page and said attribute identifier to said server.

14. A computer readable non-transitory storage medium storing instructions of a plug-in for a browser which when executed by a computer system results in performance of steps of:
providing an identifier of a web page being displayed by said web browser to a server;
receiving from the server at least one identifier associating an attribute with a form field of the web page;
obtaining a respective user value associated with each of the least one attribute identifiers;
completing each form field of the web page with an associated attribute value for the user;
receiving a user selection of at least one further attribute identifier;
for each selected further attribute identifier, receiving a user selection of a form field from said web page associated with one of said at least one further attribute identifier; and
providing an indicator associating said selected form field of said web page and said attribute identifier to said server.

15. A system comprising a secure server operable to communicate across a network with a plurality of plug-ins according to claim 13, the server being arranged to:
respond to receipt of an identifier of a web page from a plug-in, to retrieve from a first database at least one indicator of an association between an attribute and a form field for the web page and to provide each indicator to said plug-in;
retrieve a user value for an identified attribute from a second secure database and to provide said user value to said plug-in;
receive a user value for an attribute from a plug-in and to store said user value for said attribute in said second secure database; and
receive an indicator associating a selected form field of said web page with an attribute and to store said indicator said first database.
